(19) United States
(12) Patent Application Publication
(10) Pub. No.: US 2001/0026304 A1
(43) Pub. Date: Oct. 4, 2001

(54) Inkjet recording apparatus

(76) Inventors: Tetsuya Matsuzaki, Fukuoka (JP); Shinichi Kitamura, Fukuoka (JP); Hiroyuki Matsuba, Fukuoka (JP); Kensei Otsubo, Fukuoka (JP)

Correspondence Address: WENDEROTH, LIND & PONACK, L.L.P., 2033 K STREET N. W., SUITE 800, WASHINGTON, DC, 20006-1021, US

(21) Appl. No.: 09/811,631

(22) Filed: Mar. 20, 2001

(30) Foreign Application Priority Data
Mar. 21, 2000 (JP) 2000-77434
Mar. 22, 2000 (JP) 2000-80461
Mar. 24, 2000 (JP) 2000-84867

(51) Int. Cl. B41J 2/175

(52) U.S. Cl. 347/85

(57) ABSTRACT

An inkjet recording apparatus ejects ink from recording heads to a recording paper, thereby attaching the ink to the medium for recording. The apparatus includes a carriage driving motor, a transfer motor, a scanner which reciprocates a carriage—having the recording heads—in a scanning direction, and a transfer machine. The transfer machine transfers the recording paper in a transfer direction perpendicular to the scanning direction. Both of the motors are located at approx. the same place in an ejecting direction of ink from the head to the paper, and at the same height of a transfer path of the paper or on the carriage side with respect to the transfer path.

### FIELD OF THE INVENTION

The present invention relates to an inkjet recording apparatus which ejects ink from a recording head to a recording medium and attaches the ink onto the medium, thereby performing the recording.

### BACKGROUND OF THE INVENTION

Conventionally, an inkjet recording apparatus, which ejects ink from a recording head to a recording medium and attaches the ink onto the medium thereby performing the recording, has been known in the market.

In this conventional apparatus, a carriage to which the recording head is mounted reciprocates in a scanning direction, while the recording medium, such as a sheet of paper, is transferred in a direction perpendicular to the scanning direction. Positions of the recording head and the recording paper as well as ejection of the ink from the head are controlled, so that the ink is attached to a specified position on the recording paper for recording. In this apparatus, a carriage driving motor, as a driver, reciprocates the carriage in the scanning direction, while a transfer motor, as a driver, transfers the recording paper in a transfer direction.

High speed recording is demanded for the inkjet recording apparatus, while downsizing the apparatus is also required. For realizing the high speed recording, the carriage and the recording paper must move at high speed. For instance, it is desirable to employ a high-power carriage driving motor and a high-power transferring motor. However, the high-power motor needs a larger outer diameter or a longer length along a rotating axis, so that a size of the motor must be bulky.

On the other hand, on a transfer path of the recording paper or in a travel space where the carriage reciprocates, no components should be placed. Thus these motors must be placed outside from those path and travel space, and large additional space must be provided for disposing these motors. As a result, high-speed recording is achieved at the cost of increasing the size of the apparatus.

As such, the inkjet recording apparatus has encountered with contradictory requirements, i.e., high-speed recording and downsizing.

In order to solve the problem of these contradictory requirements, the following structure is designed: the carriage and an ink-tank are coupled each other with ink supplying tubes, and the ink-tank is disposed outside of the carriage. Ink in the ink-tank is supplied to recording heads of the carriage via. the tubes. However, even for an apparatus in this structure, it is very difficult to dispose the tubes so that the ink can be supplied in a stable manner for recording at high-speed, e.g., ink ejecting frequency is not less than 18 kHz.

When these tubes are bent with a curvature as small as an electric wiring can be bent, a flowing path bent is damaged. The smaller diameter of the tube, the smaller curvature the tube can be bent; however, resistance in the flowing path against the ink increases due to narrowing the diameter of the tube.

Therefore, these tubes are desirably disposed with rather larger curvatures, which, however, requires larger space and results in a bulky apparatus.

Even if the tubes are disposed with rather larger curvatures, the carriage is placed distantly from the ink-tank, so that the tubes must be longer. This results in greater resistance from the flow-path against the ink flowing, so that the ink cannot be supplied in the stable manner. In addition to this, the distant placing of the ink-tank from the carriage invites a bulky apparatus. Further, the narrower and longer tubes yield greater flow path resistance against the flowing ink, which prevents high-speed printing.

### SUMMARY OF THE INVENTION

The present invention addresses the problem discussed above, and aims to provide an inkjet recording apparatus in which the two contradictory requirements, i.e., high-speed recording and downsizing, are compatible.

The inkjet recording apparatus of the present invention comprises the following elements:

(a) recording heads mounted to a carriage and ejecting plurality of colored inks;

(b) ink tanks for pooling ink of respective colors; and

(c) a plurality of ink supplying tubes for coupling the recording heads to ink tanks so that the ink of each color in the ink tanks is supplied to the recording heads respectively.

Where, a specific color ink is ejected greater amount per unit time than other colored inks, and an ink supplying tube for the specific color supplies greater amount than other tubes assigned to other colors.

Another inkjet recording apparatus of the present invention comprises the following elements:

(a) recording heads mounted to a carriage and ejecting a plurality of colored inks;

(b) ink tanks for pooling ink of respective colors; and

(c) a plurality of ink supplying tubes for coupling the recording heads to ink tanks so that the ink of each color in the ink tanks is the recording heads respectively.

Where, viscosity of a specific color of ink is greater than those of other colors of ink, and ink supplying tube for the specific color supplies equal to or greater amount than tubes assigned to other colors.

Still another inkjet recording apparatus of the present invention comprises the following elements:

(a) a scanner having a carriage-driving-motor for reciprocating a carriage having recording heads in a scanning direction (X axis direction); and

(b) a transfer machine having a transfer motor for transferring a recording paper in a transfer direction (Y axis direction) perpendicular to the scanning direction.

Where, both the motors are at approx. the same place regarding an ink-ejecting-direction (Z axis direction). Actually, the motors are disposed at the height of the transfer-path of the recording paper, or the motors are disposed on the carriage side with respect to the transfer path.

Still further, another inkjet recording apparatus of the present invention comprises the following elements:

(a) a carriage having recording heads and reciprocating in a scanning direction;

(b) ink tanks containing ink to be supplied to the recording heads;

(c) ink supplying tubes routed from the carriage to the ink tanks via travel space for the carriage reciprocating, thereby coupling the carriage to the ink tanks.

Where, the inks ejected from the recording heads are attached to a recording paper transferred in a transfer direction perpendicular to a scanning line, thereby performing the recording.

Still another inkjet recording apparatus of the present invention comprises the following elements:

(a) recording heads for ejecting different colored ink independently;

(b) a carriage having the recording heads and reciprocating in a scanning direction (X axis direction);

(c) a plurality of ink tanks aligned in the scanning direction and containing respective colors of ink to be supplied to the recording heads;

(d) ink supplying tubes routed from the carriage to the ink tanks via travel space for the carriage reciprocating, thereby coupling the carriage to the ink tanks; and

(e) a coupling section disposed on the ink tank side of the carriage travel space and bundling the ink supplying tubes.

Where, among the plurality of ink tanks, the ink tank containing the ink of the highest viscosity is placed closest to the coupling section. The ink ejected from the recording heads is attached to a recording paper transferred in a transfer direction (Y axis direction) perpendicular to the scanning direction thereby performing the recording.

Still another inkjet recording apparatus of the present invention comprises the following elements:

(a) recording heads for ejecting different colored inks independently;

(b) a carriage having the recording heads and reciprocating in a scanning direction (X axis direction);

(c) a plurality of ink tanks aligned in the scanning direction and containing respective colors of ink to be supplied to the recording heads;

(d) ink supplying tubes routed from the carriage to the ink tanks via travel space for the carriage reciprocating, thereby coupling the carriage to the ink tanks; and

(e) a coupling section disposed on the ink tank side of the carriage travel space and bundling the ink supplying tubes.

Where, among the plurality of ink tanks, the tank containing the ink most consumable is placed closest to the coupling section. The ink ejected from the recording heads is attached to a recording paper transferred in a transfer direction (Y axis direction) perpendicular to the scanning direction thereby performing the recording.

Still another inkjet recording apparatus of the present invention comprises the following elements:

(a) recording heads for ejecting ink;

(b) a carriage having recording heads and for reciprocating in a scanning direction (X axis direction);

(c) ink tanks containing ink to be supplied to the recording heads; and

(d) ink supplying tubes for coupling the carriage to the ink tanks.

Where, the ink supplying tubes are coupled to a side of the carriage in a transfer direction (Y axis direction) perpendicular to the scanning direction, i.e., a side section of the carriage in Y direction. The ink supplying tube is also bowed toward a first side in the scanning direction (X axis direction) at a space adjacent to the carriage moving space on the side of Y direction. When the carriage is placed at the end of the first side of the scanning direction, an end position of the bowed section is placed at approx. the same position as the end of the first side in the scanning line. Or the end position of the bowed section is placed on a second side from the end of the first side in X axis direction.

The present invention can provide inkjet recording apparatuses in which high-speed recording and downsizing of the apparatus are compatible thanks to the structures discussed above.

### BRIEF DESCRIPTION OF THE DRAWINGS

FIG. 1 is a schematic perspective view of an inkjet recording apparatus in accordance with a first exemplary embodiment of the present invention.

FIG. 2 is a schematic perspective view of ink supplying tubes of the inkjet recording apparatus shown in FIG. 1.

FIG. 3 is a schematic perspective view of ink supplying tubes of an inkjet recording apparatus in accordance with a second exemplary embodiment of the present invention.

FIG. 4 is a schematic perspective view of a modification of the ink supplying tube in the same apparatus shown in FIG. 3.

FIG. 5 is a schematic perspective view of an ink supplying tubes of an inkjet recording apparatus in accordance with a third exemplary embodiment.

FIG. 6 is a schematic perspective view of an ink supplying tubes of an inkjet recording apparatus in accordance with a fourth exemplary embodiment.

FIG. 7 is a plan view of an inkjet recording apparatus in accordance with a fifth exemplary embodiment.

FIG. 8 is a perspective view of the inkjet recording apparatus in accordance with the fifth exemplary embodiment.

FIG. 9 is an enlarged view of recording heads of the apparatus shown in FIG. 8.

FIG. 10 is a perspective view of an inkjet recording apparatus in accordance with a sixth exemplary embodiment.

FIG. 11 is a perspective view of an inkjet recording apparatus in accordance with a seventh exemplary embodiment.

FIG. 12 is a perspective view of an inkjet recording apparatus in accordance with an eighth exemplary embodiment.

FIG. 13 is a perspective view of an inkjet recording apparatus in accordance with a ninth exemplary embodiment.

FIG. 14 is a lateral view of an inkjet recording apparatus in accordance with a tenth exemplary embodiment.

FIG. 15 is a plan view of the inkjet recording apparatus shown in FIG. 14.

FIG. 16 is an enlarged view of recording heads of the apparatus shown in FIG. 14.

FIG. 17 is a lateral view of a first modification of the inkjet recording apparatus in accordance with the tenth embodiment.

FIG. 18 is a lateral view of a second modification of the inkjet recording apparatus in accordance with the tenth embodiment.

FIG. 19 is a lateral view of an inkjet recording apparatus in accordance with a eleventh exemplary embodiment.

FIG. 20 is a plan view of the inkjet recording apparatus in accordance with the eleventh exemplary embodiment.

### DETAILED DESCRIPTION OF THE EXEMPLARY EMBODIMENTS

Exemplary embodiments of the present invention are demonstrated hereinafter with reference to the accompanying drawings.

First Exemplary Embodiment

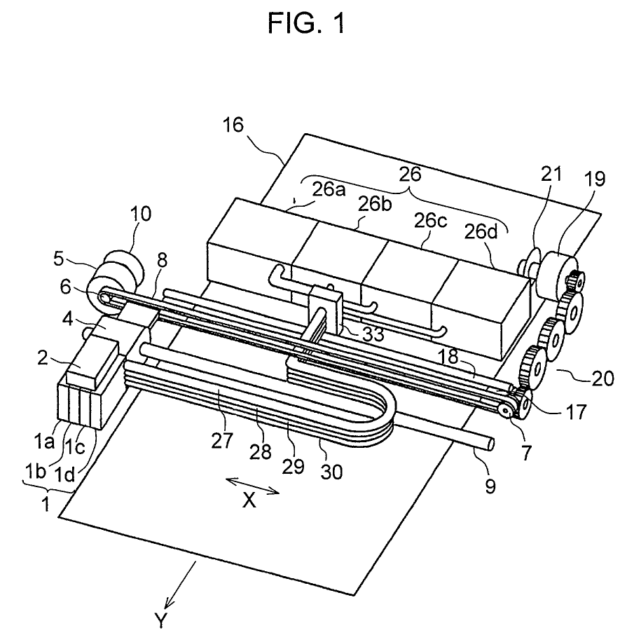

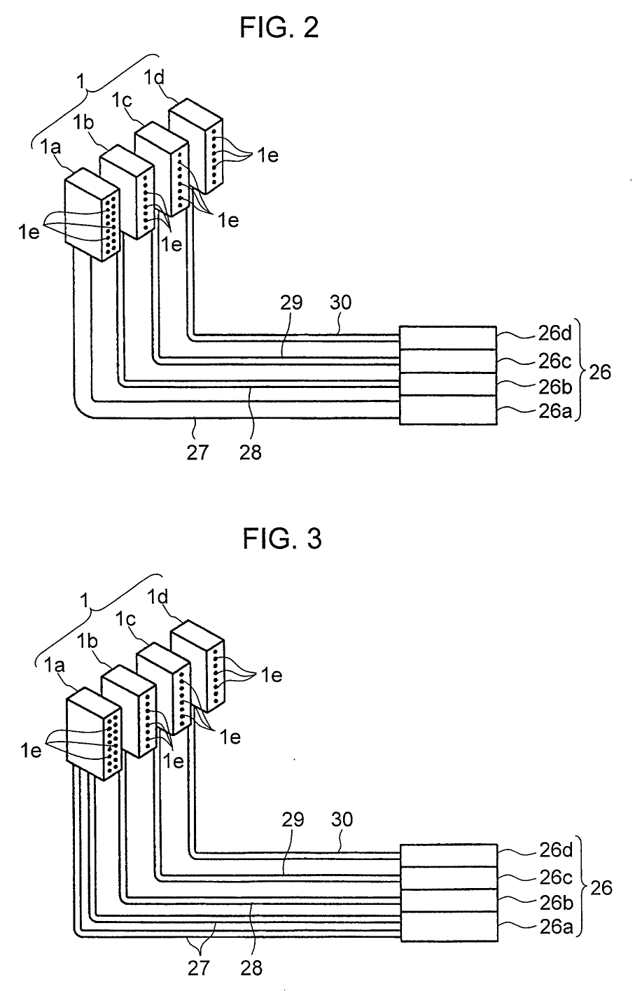

FIG. 1 is a schematic perspective view of an inkjet recording apparatus in accordance with a first exemplary embodiment of the present invention. FIG. 2 is a schematic perspective view of ink supplying tubes of the inkjet recording apparatus shown in FIG. 1.

In the inkjet recording apparatus shown in FIG. 1, recording heads 1 eject inks of a plurality of colors. These heads 1 comprise black-ink-ejecting section 1a, yellow-ink-ejecting section 1b, magenta-ink-ejecting section 1c and cyan-ink-ejecting section 1d. These ejecting sections 1a, 1b, 1c and 1d are aligned in a moving direction of carriage 4 (X direction shown in FIG. 1.)

On the lower faces of each ejecting section, a plurality of nozzles 1e, having the same diameter, are formed as shown in FIG. 2. FIG. 2 illustrates schematically the details of ink-supplying-tubes 27-30 such as a diameter, number of nozzles, length, and the like. The positional relation between heads 1 and ink tanks 26 and curvatures of tubes 27-30 are different from those shown in FIG. 1.

Pressuring chambers (not shown) in which the ink is filled are provided at places corresponding to each nozzle 1e in respective ejecting sections. Piezoelectric actuators (not shown) are also provided at the same places, and they have a piezoelectric element to which pulse-shaped voltage is applied, thereby reducing a capacity of the pressuring room, which results in deforming the pressuring room. This piezoelectric actuator is activated by driving circuit 2, so that ink in the pressuring chamber is ejected through nozzle 1e to recording paper 16 under the nozzles. Recording paper 16 is transferred by transfer motor 19 in Y direction shown in FIG. 1.

A number of nozzles 1e assigned to black ink (a specified color) ejecting section 1a is greater than those to other ejecting sections 1b, 1c and 1d. Therefore, the amount of black ink per unit time ejected from nozzles 1e of ejecting section 1a is greater than those of ink in other colors ejected from nozzles 1e of other ejecting sections.

Head 1 is rigidly mounted to carriage 4 which is relatively movable with respect to recording paper 16. Carriage 4 forms right angles with a transfer direction (Y direction) of paper 16 and is disposed on a first side of a direction (X direction shown in FIG. 1) along paper 16. Carriage 4 is mounted to guide shaft 9 such that shaft 9 extends through carriage 4, and is fixed at a span under carriage driving belt 8. Belt 8 is wound on driver pulley 6 driven by carriage driving motor 5 disposed on a first side and follower pulley 7 disposed on a second side. Shaft 9 is supported by the apparatus itself (not shown) and extends along X axis. This structure allows pulley 6 to rotate thereby driving belt 8, and then carriage 4, i.e., recording head 1, reciprocates in X direction being guided by shaft 9. Motor 5 includes rotary detector 10 which is combined with a detecting sensor (not shown) to detect rotational volume of motor 5, i.e., position of head 1 in X direction.

Paper 16 is pinched between transfer roller 17 and pressure roller 18. Both the rollers extend in X direction, and roller 18 is urged to upper surface of roller 17 by a given pressure. Transfer motor 19 is disposed at rear side of transfer direction of paper 16 with respect to roller 18. The rotation of motor 19 is transmitted to roller 17 via gear row 20. Rotation of roller 17 transfers paper 16 in Y direction. Motor 19 includes rotary detector 21 which is combined with a detecting sensor (not shown) to detect rotational volume of motor 19, i.e., transferred volume of paper 16 in Y direction.

Between roller 18 and motor 19, there are ink tanks 26—containing ink of respective colors—fixed to the apparatus itself (not shown). In other words, ink tanks 26 are not disposed on carriage 4 (recording head 1) but disposed to somewhere of the apparatus itself other than carriage 4. Tank 26 comprises four individual tanks as follows: black ink tank 26a, yellow ink tank 26b, magenta ink tank 26c, and cyan ink tank 26d. These four individual tanks are aligned in X direction.

Four ink-supplying-tubes 27-30 couple head 1 to tanks 26 and the tubes supply the ink of respective colors in the individual tanks to heads 1. One piece of tube 27 couples black ink ejecting section 1a of head 1 to black ink tank 26a, and tube 28 couples yellow ink ejecting section 1b to yellow ink tank 26b. Tube 29 couples magenta ink ejecting section 1c to magenta ink tank 26c, and tube 30 couples cyan ink ejecting section 1d to cyan ink tank 26d. Coupling member 33 is disposed near the front side of tank 26 with respect to transfer direction of paper 16. These four tubes 27-30 are bundled in vertical direction by coupling member 33. The tubes extend in Y direction, then extend toward the second side in X direction, i.e., toward pulley 7 side, then curve and extend toward the first side in X direction, i.e., toward pulley 6 side, and finally arrive at head 1. Thus when head 1 moves in X direction together with carriage 4, curved sections of tubes 27-30 move so that tubes 27-30 do not prevent head 1 from moving. Tubes 27-30 between coupling member 33 and head 1 are vertically adjacent, and approx. contact with each other; however, they are not bonded (they can be bonded.)

Black ink supplying tube 27 supplies greater amount of ink than other tubes 28-30. To be more specific, tubes 28-30 for yellow, magenta and cyan inks have the same diameter, while tube 27 for black ink has a larger diameter along the entire length.

This structure allows the black ink to flow in a greater amount than other colored inks, and allows fluid resistance in tube 27 to lower. Thus the supplying amount of black ink per unit time can be greater than other colored inks. As a result, black ink can be supplied to black ink ejecting section 1a without fail although a number of nozzles 1e at ejecting section 1a is greater than those of other ejecting sections 1b, 1c and 1d, as well as, the ejected amount of black ink per unit time is greater than other inks. On the other hand, since only tube 27 among others is enlarged its diameter, the apparatus is restrained from becoming larger. As such, the printing speed with black ink can be faster, while a size of the apparatus is restrained from becoming larger.

In this first embodiment, the diameter of tube 27 is greater than other tubes 28-30 along the entire length; however, when only a part of the tube has a greater diameter than other tubes 28-30, the fluid resistance the black ink bears decreases accordingly. Thus the supply amount of black ink per unit time can be greater than other colored inks.

Second Exemplary Embodiment

FIG. 3 is a schematic perspective view of ink supplying tubes of an inkjet recording apparatus in accordance with the second exemplary embodiment of the present invention.

In FIG. 3, the same elements shown in FIG. 2 bear the same reference marks, and descriptions thereof are thus omitted. In the second embodiment, black ink supplying tube 27 shown in FIG. 2 of the first embodiment is modified. To be more specific, in the second embodiment, two pieces of tube 27 are provided, i.e. a greater number of black ink supplying tubes than other tubes for other colored inks are available. The two tubes are independently formed, and their diameters are the same as those of other tubes 28-30.

Therefore, in this second embodiment, flowing amount of the black ink comes greater than those of other colored inks, and supply amount of the black ink per unit time can be greater than those of other colored inks. As a result, the same advantage as the first embodiment is obtainable.

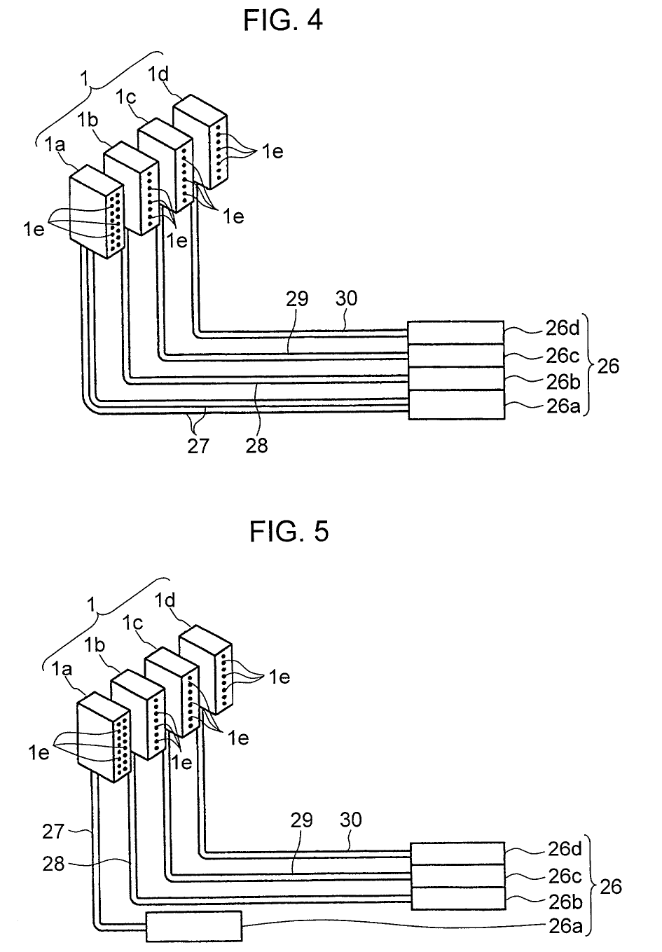

FIG. 4 is a schematic perspective view of a modification of the ink supplying tube in accordance with the second embodiment of the present invention. In the second embodiment, two tubes 27 are independently formed; however, in the modification shown in FIG. 4, two tubes 27 are integrated into one unit. Three or more than three tubes 27 can be provided. In this case, all the tubes can be integrated into one unit, or at least two of them can be integrated into one unit.

Third Exemplary Embodiment

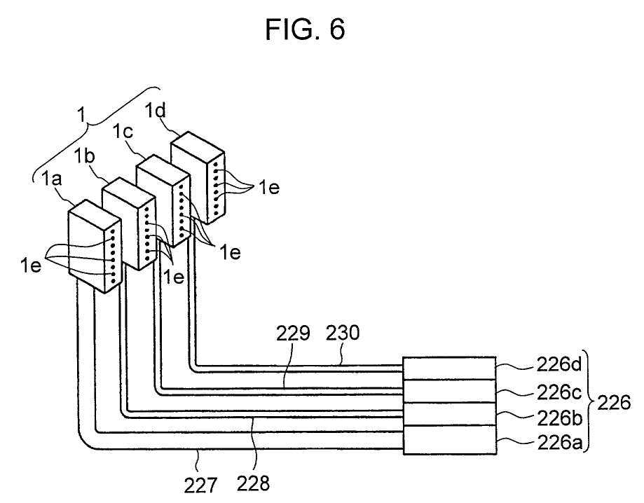

FIG. 5 is a schematic perspective view of an ink supplying tubes of an inkjet recording apparatus in accordance with the third exemplary embodiment.

In FIG. 5, the same elements shown in FIG. 2 bear the same reference marks, and descriptions thereof are thus omitted. In this third embodiment, respective ink-supplying-tubes 27-30 have the same diameter and the same number of tubes are assigned to respective colors. However, tube 27 for black ink has a shorter length than other tubes 28-30.

To be more specific, black ink tank 26a is disposed away from other tanks 26b, 26c and 26d. Black ink supplying tube 27 is routed in a different way from other tubes, such as not via coupling member 33, and arrives at black ink ejecting section 1a of head 1.

The shorter length of tube 27 allows the black ink to bear a large fluid resistance within a shorter length than other colored inks which travel in longer length of tubes 28-30. Therefore, the supply amount of black ink per unit time can be greater than other colored inks. As a result, the same advantage as the first and second embodiments can be obtained.

In the first through the third embodiments, a number of nozzles 1e of black ink ejecting section 1a is greater than those of other ejecting sections 1b, 1c and 1d. However, if the number of nozzles is the same as others, a diameter of nozzle 1e can be greater than those of others, or a waveform of a voltage applied to the piezoelectric element corresponding to nozzle 1e can be changed from those of other nozzles. Thus a supply amount of the black ink per unit time can be greater than those of other colored inks.

A supply amount of any specific color per unit time can be increased, and it is not limited to the black color. The specific color is not always one color but two or more colors can be assigned to the specific colors. A supply amount from any specific colored ink supplying tube per unit time can be greater than those of other supplying tubes.

Fourth Exemplary Embodiment

FIG. 6 is a schematic perspective view of an ink supplying tubes of an inkjet recording apparatus in accordance with the fourth exemplary embodiment.

In FIG. 6, the same elements shown in FIG. 2 bear the same reference marks, and descriptions thereof are thus omitted. In this fourth embodiment, viscosity of black ink is greater than those of other colored inks. To be more specific, colored inks other than black employ dye type inks, while black ink employs pigment type ink of which viscosity is greater than that of the dye type.

Supply amount from black ink supplying tube 227 per unit time is not less than those of other tubes 228-230. In other words, the diameter of tube 227 is larger than those of other tubes 228-230 along the entire length. Only a part of tube 227 can have a greater diameter than others.

This structure allows the supply amount of the black ink to be not less than those of other colored ink although the viscosity of the black ink is greater than those of other colored ink. As a result, the black ink can be positively supplied to its ejecting section 1a without lowering printing speed, so that clear and crisp printing in black ink can be achieved.

In this fourth embodiment, the diameter of tube 227 is greater than those of tubes 228-230. However, as demonstrated in the second embodiment, the number of tubes 227 can be greater than numbers of other tubes 228-230, or as demonstrated in the third embodiment, the length of tube 227 can be shorter than those of other tubes 228-230. In this fourth embodiment, pigment type ink is used as the black ink; however, it is not limited to the pigment type but the viscosity of the black ink can be greater than other inks in any way. A specific color having a greater viscosity is not limited to the black ink but other inks can have. The specific color is not always limited to one color but two or more colors can be available to the specific color, and the supply amount from the specific colored ink supplying tube can be not less than those from other colored ink supplying tubes.

As discussed above, in the inkjet recording apparatus in accordance with the first through the fourth embodiment, ejected amount of a specific colored ink from the nozzles per unit time is set greater than those of other colored inks. The ink-supplying-tube for the specific colored ink is designed to supply greater amount of ink per unit time than other ink-supplying-tubes. In another inkjet recording apparatus, viscosity of a specific colored ink is set greater than those of other colored inks, and the ink-supplying-tube for the specific colored ink is designed to supply greater amount of ink per unit time than other ink-supplying-tubes. According to the first through the fourth embodiment, the apparatus is restrained from being greater size, while a specific colored ink is positively supplied to a recording head. As a result, printing speed with the specific colored ink can be increased, or a clear printing in the specific colored ink is obtainable.

Fifth Exemplary Embodiment

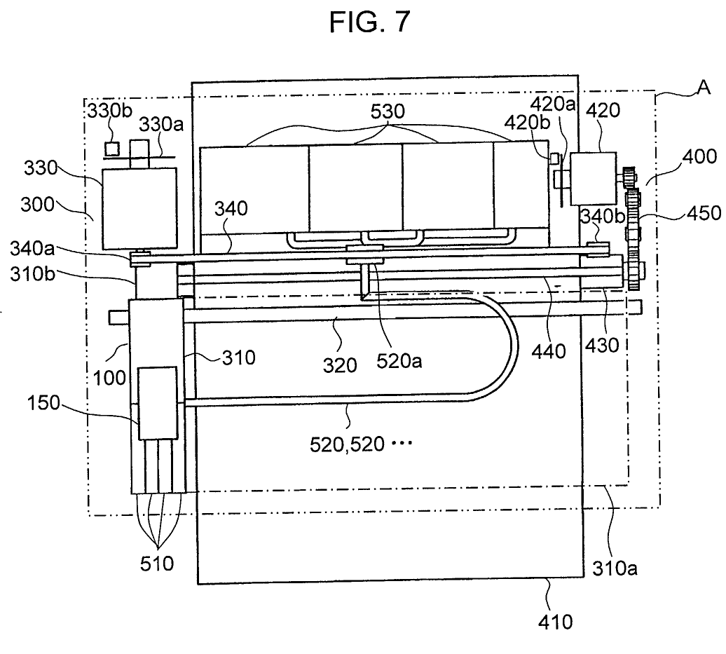

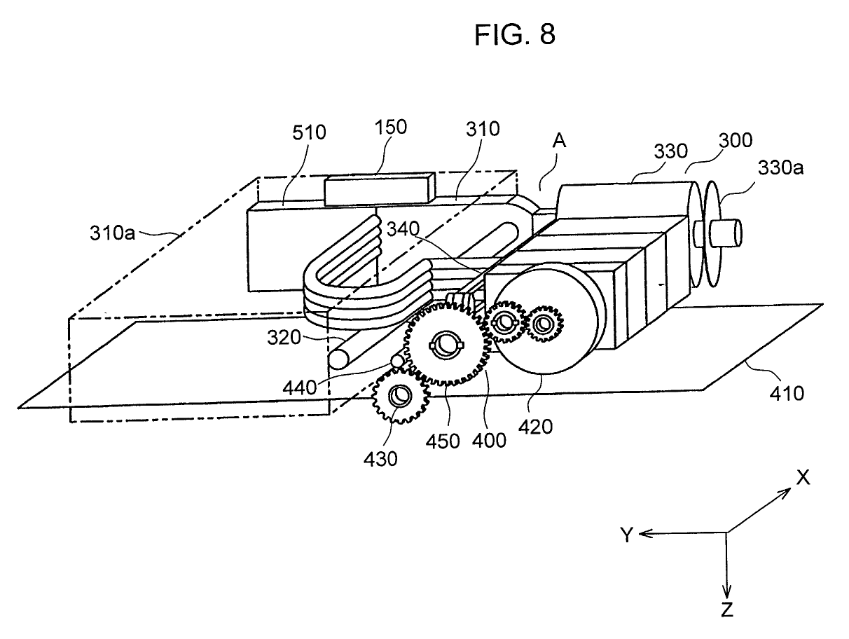

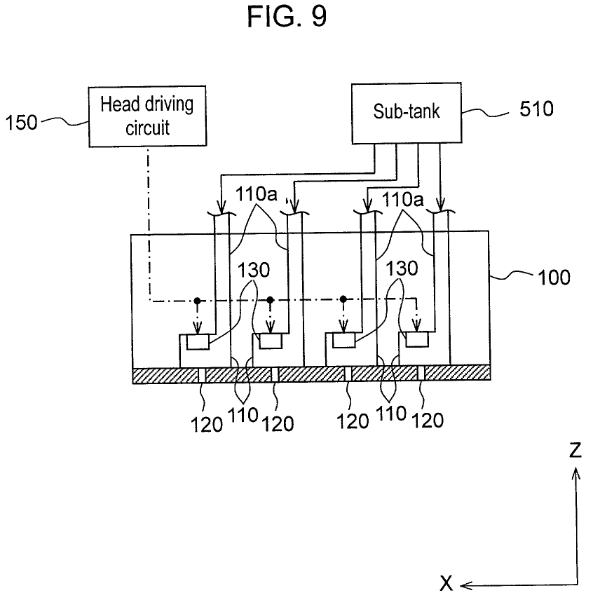

FIG. 7 is a plan view of an inkjet recording apparatus in accordance with the fifth exemplary embodiment. FIG. 8 is a perspective view of the same apparatus. FIG. 9 is an enlarged view of recording heads of the apparatus shown in FIG. 8.

As shown in FIGS. 7 and 8, inkjet recording apparatus A ejects the inks of yellow, magenta, cyan and black respectively from recording heads 100 to recording paper 410, thereby performing color recording on paper 410.

Heads 100 are provided to carriage 310, and scanner 300 reciprocates carriage 310 in a scanning direction (X direction shown in FIG. 8.) Transfer machine 400 transfers recording paper 410 in a transfer direction (Y direction shown in FIG. 8) perpendicular to the scanning direction.

Carriage moving space 310a—the space where the carriage 310 reciprocates in the scanning direction—extends in the scanning direction. Carriage 310 reciprocates within space 310a in the scanning direction, so that heads 100 reciprocate also in the scanning direction. Scanner 300 comprises carriage shaft 320 for guiding carriage 310, carriage driving motor 330 as a driving source for reciprocating carriage 310, and carriage driving belt 340 for transferring carriage 310.

Shaft 320 is disposed extending in the scanning direction. Carriage 310 is mounted to shaft 320 so that carriage 310 moves along shaft 320 being guided by shaft 320. Belt 340 winds on driver pulley 340a and follower pulley 340b spaced each other in the scanning direction.

Motor 330 is adjacent to space 310a with respect to the transfer direction and disposed on a first side of the scanning direction. As shown in FIG. 8, motor 330 is disposed on the side of carriage 310 with respect to the transfer path, i.e., upstream side in the ink ejecting direction with respect to the transfer path (Z direction shown in FIG. 8). Pulley 340a is mounted to a rotary shaft of motor 330, and spinning of motor 330 entails pulley 340a to spin. The spin of pulley 340a is transferred to pulley 340b via belt 340.

On carriage 310, engaging section 310b for engaging with belt 340 is formed. When belt 340 is driven, engaging section 310b is transferred by belt 340, therefore, the rotary shaft of motor 330 is normally driven or reversedly driven, so that carriage 310 reciprocates in the scanning direction. Transfer machine 400 comprises: transfer motor 420 as a driving source for transferring meidum 410; transfer rotor 430 and pressing rotor 440 both for pinching and transferring paper 410. Motor 420 is adjacent to space 310a in the transfer direction and disposed on a second side of the scanning direction. In other words, motor 420 is disposed away from motor 330 in the scanning direction. Therefore, motor 330 and motor 420 are disposed at respective corners of apparatus A. (Refer to two-dot chain lines in FIG. 7.)

Motor 420 is disposed on upstream side in the ink ejecting direction (Z direction shown in FIG. 8) with respect to the transfer path. In other words, as shown in FIG. 8, motor 420 and motor 330 are disposed at approx. the same place on Z axis. Roller 430 is disposed extending in the scanning direction, and has a gear on its tip. The gear engages with a plurality of gears 450 in series and finally engages with the rotary shaft of motor 420. This structure allows roller 430 to rotate around the rotary shaft of motor 420 when the rotary shaft of motor 420 spins. Roller 440 faces roller 430, and urges paper 410 against roller 430. Thus when motor 420 spins, paper 410 pinched between roller 430 and roller 440 is transferred in the transfer direction.

On each shaft of motor 330 and motor 420, rotary detectors 330a and 420a are mounted. In order to detect a rotating angle of rotary detector 330a and 420a, rotating angle detecting sensors 330b and 420b are disposed and face the rotary detectors. Motor 330 and motor 420 are controlled based on rotating angles of respective rotary shafts thereof. The rotating angles are detected by sensors 330b and 420b. Controlling of both the motors also controls the position of carriage 310 and the position of paper 410. These two motors are rather high power motors and in rather large shapes.

Recording head 100 disposed to carriage 310 is now described. FIG. 9 is an enlarged view of the recording head of the apparatus. Head 100 comprises the following elements:

(a) a plurality of pressuring chambers 110 in which colored inks such as yellow, magenta, cyan and black are filled;

(b) a plurality of nozzle-holes 120 disposed on walls defining respective chambers 110, and for ejecting the inks from chambers 110; and

(c) actuators 130 actuating and deforming so that capacities of respective chambers 110 decrease.

Ink flow-paths 110a, through which the ink is supplied, communicate with chambers 110. These paths 110a are coupled to sub-tank 510 mounted to carriage 310.

Actuator 130 is disposed on the walls of chambers 110 facing the walls on which nozzle-holes 120 are formed. Actuator 130 is formed by piezoelectric film pinched by a pair of electrodes. A pulse is applied over the pair of electrodes, and a rise of pulse voltage makes actuator 130 bow downwardly (protrudes inside of chamber 110) due to bimetal effect. This deflection ejects the ink in chamber 110 through nozzle-hole 120 toward paper 410. On the other hand, a fall of pulse voltage restores actuator 130, then ink is filled in chamber 110 through flow path 110a. The voltage applied to actuator 130 is controlled by head driving circuit 150 disposed on carriage 310. Driving circuit 150 controls the deforming of actuator 130, so that ejection of the ink is controlled.

Sub-tanks 510 are provided for respective colored inks. As shown in FIGS. 7 and 8, sub-tanks 510 are mounted to carriage 310 and reciprocate together with carriage 310 in space 310a in the scanning direction. Ink supplying tubes 520 (four tubes in total) of respective colors are coupled to each sub-tank 510. These tubes 520 are aligned in an ejecting direction (Z axis direction) and integrated into one unit. Tubes 520 run through space 310a and arrive at coupling member 520a disposed at approx. center in the scanning direction (X axis direction.) At coupling member 520a, tubes 520 are separated into respective colors, and coupled to respective main tanks 530 containing respective colored inks. Respective main tanks 530 are divided into four respective colors and aligned in the scanning direction (X axis direction), and placed between motor 330 and motor 420. In Z axis direction, tanks 530 are disposed on the same side as carriage 310 is disposed with respect to the transfer path.

Regarding four supplying tubes 520 extending between coupling member 520a and carriage 310, power lines for driving circuit 150 and other wires for signals (not shown) are integrally routed in parallel with tubes 520.

An operation and advantages of the fifth embodiment are demonstrated hereinafter. As shown in FIG. 8, carriage driving motor 330 and transfer motor 420 do not interfere with each other on the transfer path of paper 410. Because both the motors are disposed on the same side as carriage 310 is disposed with respect to the transfer path in the ejecting direction (Z axis direction) viewed from the scanning direction (X axis direction).

Further, since both the motors are disposed at approx. the same place regarding Z axis direction, a space for one motor can accommodate the two motors in Z axis direction. Therefore, apparatus A can be downsized substantially in Z axis direction.

As discussed above, since both the motors are disposed on the same side as carriage 310 is disposed with respect to the transfer path, both the motors can be placed in a space adjacent to carriage-moving-space 310a. Therefore, no additional space is required only for accommodating both the motors. As a result, even if both the motors are rather in large sizes, apparatus A can be downsized.

Still further, both the motors generate heat due to operation; however since they are disposed away from each other in the scanning direction (X axis direction), apparatus A does not encounter a local high temperature. Thus troubles due to heat can be avoided.

Both the motors are away from each other in the scanning direction, thus main tanks 530 can be disposed in a space extending between both the motors. Therefore, no additional space is required only for accommodating tanks 530. As a result, apparatus A can be downsized in both the ejecting direction and transfer direction.

The space between both the motors is rather large, thus the capacities of tanks 530 can be increased. This is convenient for a certain type of tanks 530, which ejects greater amount of ink per unit time at higher recording speed. Further, tanks 530 are disposed at a place adjacent to carriage moving space 310a in the transfer direction. Thus the length of ink-supplying-tubes 520 becomes short, and flow path resistance in tube 520 against the ink becomes less, so that the ink can be supplied in a stable manner to recording head 100. As a result, stable recording is achievable, and high-speed apparatus A is obtainable.

The fifth embodiment proves that even if carriage driving motor 330 and transfer motor 420 are in large sizes, apparatus A can be downsized in both the ejecting direction (Z axis direction) and the transfer direction (Y axis direction). Thus higher recording speed and downsizing of the apparatus are compatible.

Sixth Exemplary Embodiment

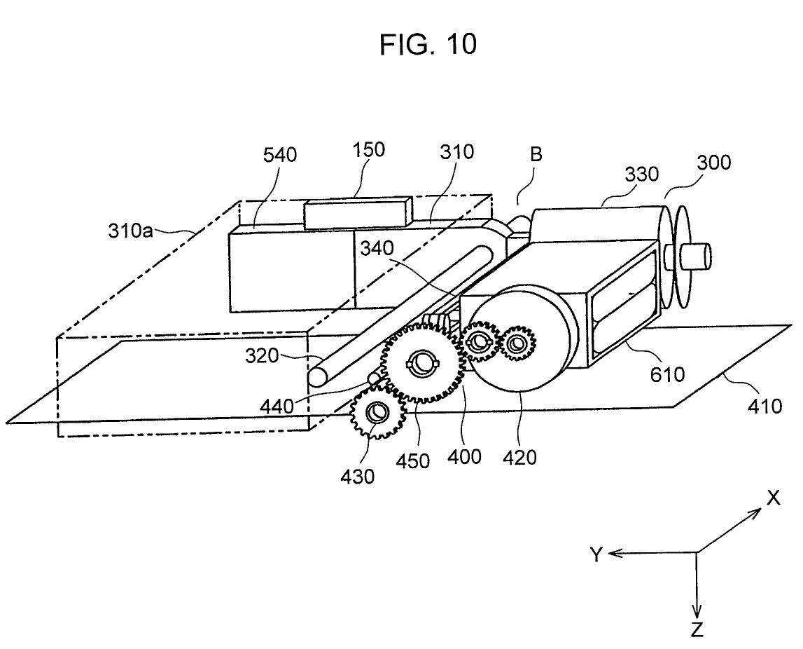

FIG. 10 is a perspective view of an inkjet recording apparatus in accordance with the sixth exemplary embodiment. The sixth embodiment differs from the fifth embodiment in the following point:

In apparatus A shown in FIG. 8 used in the fifth embodiment, the main tanks are placed between the carriage driving motor and the transfer motor. However, in ink-jet-recording apparatus B used in the sixth embodiment shown in FIG. 10, battery pack 610 as a power source is placed between carriage driving motor 330 and transfer motor 420. In other words, the main tanks are omitted in this sixth embodiment, and apparatus B has only ink tanks 540 mounted to carriage 310. Battery pack 610, instead, is placed between both the motors and on the same side as carriage 310 is disposed. Battery pack 610 powers scanner 300, transfer machine 400 and the like.

Other structures of apparatus B remain the same as that used in the fifth embodiment, and the same elements bear the same reference marks and the descriptions thereof are thus omitted here. Apparatus B in accordance with the sixth embodiment is good for portable ink-jet-recording apparatus. The space between both the motors is used for accommodating battery pack 610, thus a high-speed ink-jet-recording apparatus in a compact size is obtainable.

Seventh Exemplary Embodiment

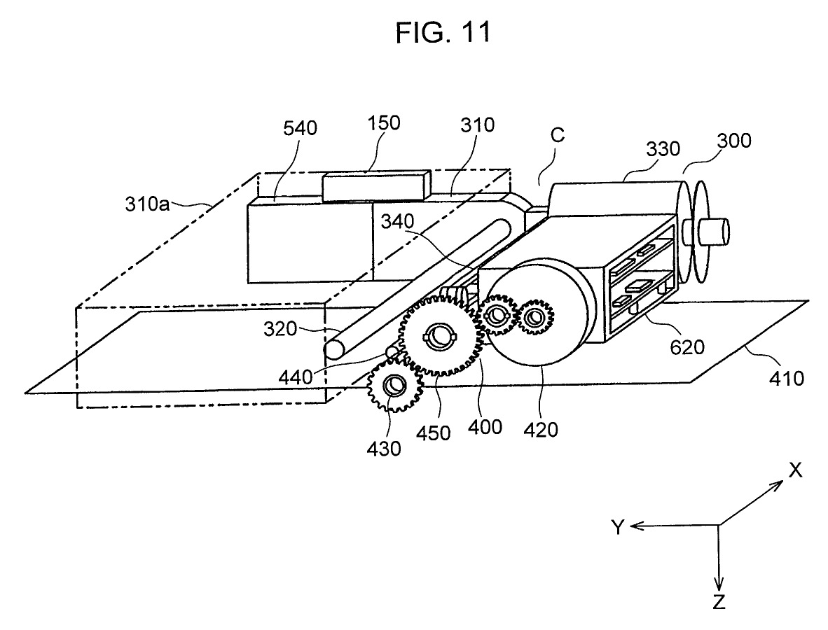

FIG. 11 is a perspective view of an inkjet recording apparatus in accordance with the seventh exemplary embodiment. The seventh embodiment differs from the fifth embodiment in the following point:

In apparatus A shown in FIG. 8 used in the fifth embodiment, the main tanks are placed between the carriage driving motor and the transfer motor. However, in ink-jet-recording apparatus C used in the seventh embodiment shown in FIG. 11, electric circuit 620 as a controller is placed between carriage driving motor 330 and transfer motor 420.

Apparatus C used in the seventh embodiment omits the main tanks and has only ink tanks 540 mounted to carriage 310, and circuit 620 controlling scanner 300, transfer machine 400 and the like is placed between both the motors. Circuit 620 is placed on the same side as carriage 310 is placed with respect to the transfer path.

Other structure of apparatus C remains the same as that used in the fifth embodiment, and the same elements bear the same reference marks and the descriptions thereof are thus omitted here. The space between both the motors is used for accommodating circuit 150, thus a high-speed ink-jet-recording apparatus in a compact size is obtainable.

Eighth Exemplary Embodiment

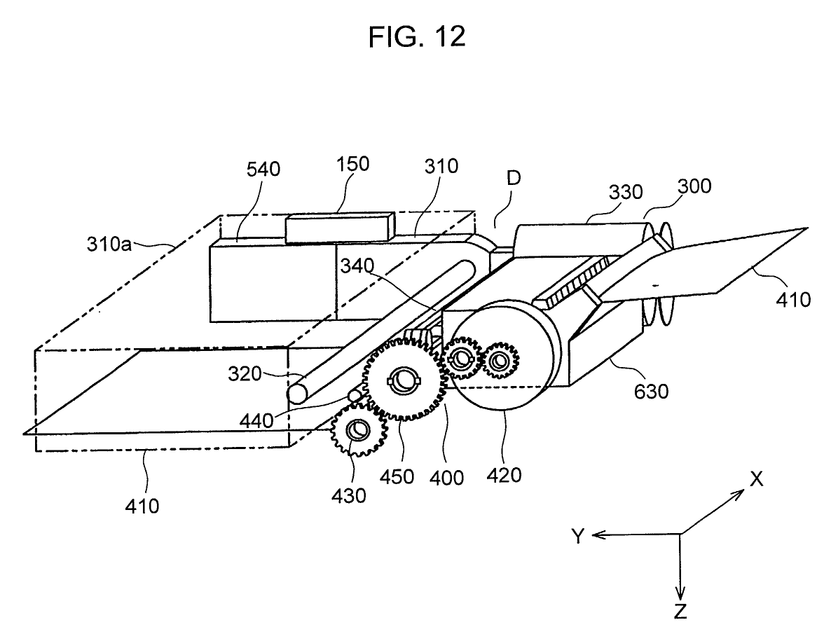

FIG. 12 is a perspective view of an inkjet recording apparatus in accordance with the eighth exemplary embodiment. The eight embodiment differs from the fifth embodiment in the following point:

In apparatus A shown in FIG. 8 used in the fifth embodiment, the main tanks are placed between the carriage driving motor and the transfer motor. However, in ink-jet-recording apparatus D used in the eighth embodiment shown in FIG. 12, feeder 630 for feeding paper 410 to transfer machine 400 is placed between carriage driving motor 330 and transfer motor 420.

Apparatus D used in the eighth embodiment omits the main tanks and has only ink tanks 540 mounted to carriage 310, and feeder 630 is placed instead between both the motors. Feeder 630 is placed on the same side as carriage 310 is placed with respect to the transfer path. Feeder 630 holds a plurality of paper 410 and supplies paper 410 one by one to transfer machine 400.

Other structures of apparatus D remain the same as that used in the fifth embodiment, and the same elements bear the same reference marks and the descriptions thereof are thus omitted here. The space between both the motors is used for accommodating feeder 630, thus a high-speed ink-jet-recording apparatus in a compact size is obtainable.

Ninth Exemplary Embodiment

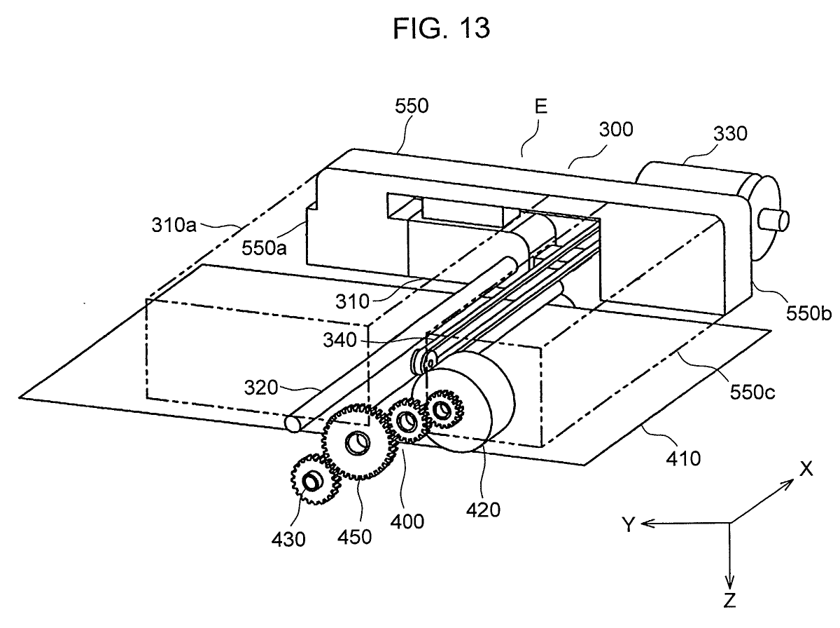

FIG. 13 is a perspective view of an inkjet recording apparatus in accordance with the ninth exemplary embodiment. The ninth embodiment differs from the fifth embodiment in the following point:

In apparatus A shown in FIG. 8 used in the fifth embodiment, the main tanks are placed between the carriage driving motor and the transfer motor. However, in inkjet-recording apparatus E used in the ninth embodiment shown in FIG. 13, the space between carriage driving motor 330 and transfer motor 420 is used as tank moving space 550c. Ink tank 550 used in the ninth embodiment comprises first tank 550a mounted to carriage 310 and second tank 550b provided in a transfer direction with respect to first tank 550a. Second tank 550b is integrated into the first tank so that it communicates with first tank 550a. Second tank 550b is disposed between both the motors and on the same side as carriage 310 is placed with respect to a transfer path. This structure allows second tank 550b to reciprocate in space 550c, while first tank 550a reciprocates within carriage-moving-space 310a following the reciprocation of carriage 310.

Other structures of apparatus E remain the same as that used in the fifth embodiment, and the same elements bear the same reference marks and the descriptions thereof are thus omitted here. In this ninth embodiment, since ink-tank 550 has first tank 550a and second tank 550b, the total capacity is greater than those of previous embodiments. Further, second tank 550b is placed between both the motors, thus the capacity thereof can be large. Therefore, apparatus E can be downsized in an ejection direction (Z axis direction) and the transfer direction (Y axis direction.) As a result, a high-speed recording apparatus can be downsized.

In the fifth through the ninth embodiment, carriage driving motor 330 and transfer motor 420 are disposed on the same side as carriage 310 is placed with respect to the transfer path. However, it is not limited to this structure, and both the motors can be placed above the transfer path in Z axis direction viewed from a scanning direction (X axis direction.) In this case, apparatus E can be downsized in the ejecting direction (Z axis direction.)

In the fifth through ninth embodiment, carriage driving motor 330 is placed so that its rotary shaft faces toward the transfer direction. However, it is not limited to this structure, and motor 330 can be placed so that the rotary shaft faces toward the scanning direction. In the same manner, transfer motor 420 is placed so that its rotary shaft faces toward the scanning direction; however, motor 420 can be placed so that the rotary shaft faces toward the transfer direction. Further, places of both the motor can be exchanged with respect to the scanning direction.

As discussed above, the inkjet recording apparatuses in accordance with the fifth through the ninth embodiment prove that when the carriage driving motor and the transfer motor are disposed at approx. the same place in the ejecting direction (Z axis direction) and above the transfer path, or disposed on the same side as the carriage is placed in Z axis direction, the apparatuses can be downsized even if both the motors are in large shapes. Therefore, a high-speed and compact recording apparatus is obtainable. Further, when both the motors are away from each other in the scanning direction, and various elements forming the apparatus are disposed in the space between both the motors, the apparatus can be downsized in both the ejecting direction (Z axis direction) and the transfer direction (Y axis direction.)

High-speed recording and a compact size can be thus compatible in an inkjet recording apparatus.

Tenth Exemplary Embodiment

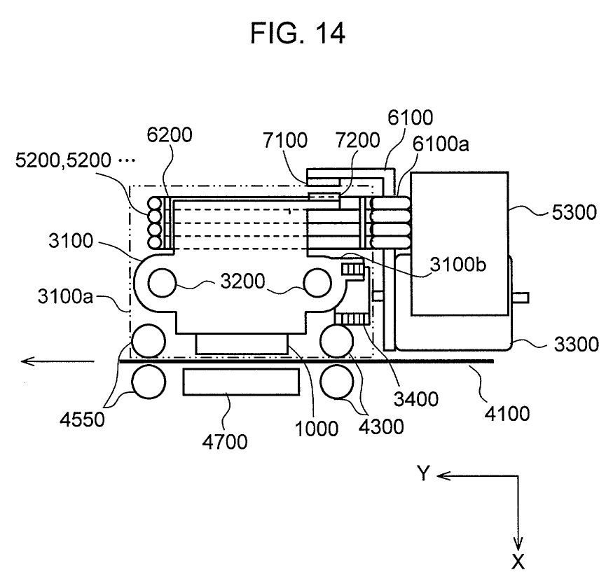

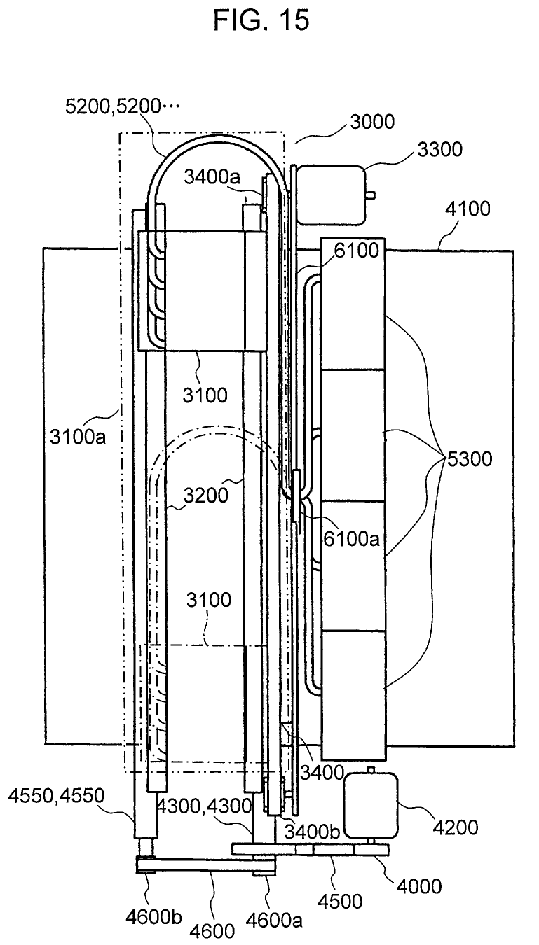

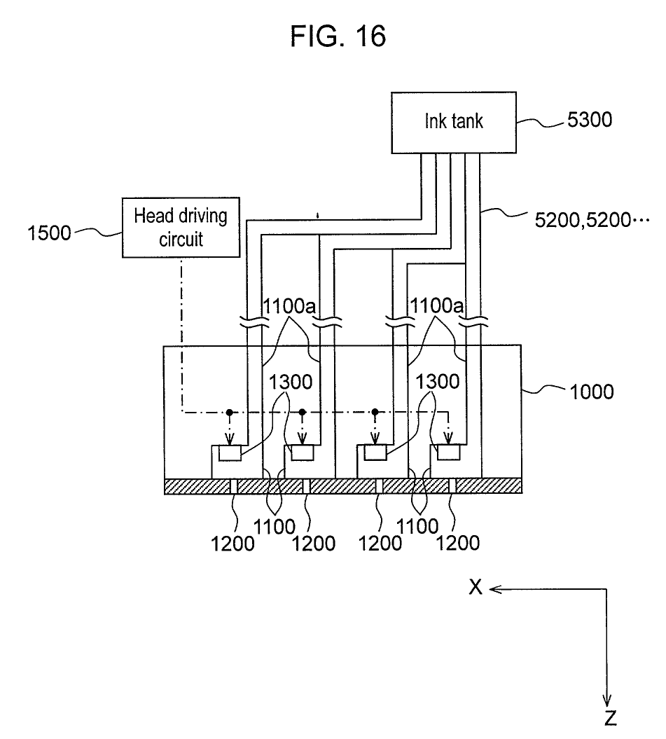

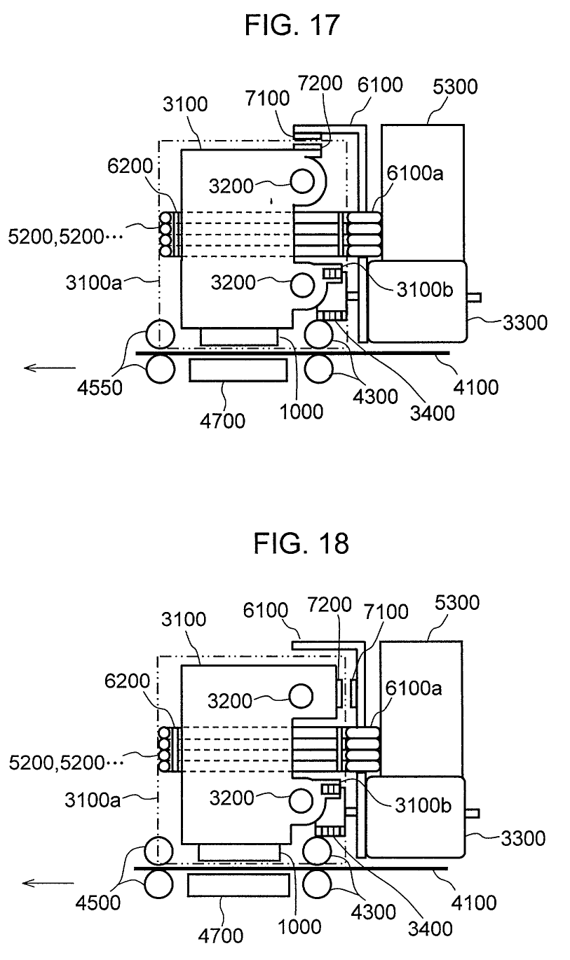

FIG. 14 is a lateral view of an inkjet recording apparatus in accordance with the tenth exemplary embodiment. FIG. 15 is a plan view of the inkjet recording apparatus shown in FIG. 14. FIG. 16 is an enlarged view of recording heads of the apparatus shown in FIG. 14. FIG. 17 is a lateral view of a first modification of the inkjet recording apparatus in accordance with the tenth embodiment. FIG. 18 is a lateral view of a second modification of the inkjet recording apparatus.

In the apparatus used in the tenth embodiment shown in FIGS. 14 and 15, colored inks such as yellow, magenta, cyan and black are ejected from recording heads 1000 to a recording medium such as a sheet of paper 4100, so that color recording is carried out on paper 4100.

Heads 1000 are disposed at carriage 3100. Scanner 3000 reciprocates carriage 3100 in a scanning direction (X direction.) Transfer machine 4000 transfers paper 4100 in a transfer direction (Y direction) perpendicular to the scanning direction.

Carriage-moving-space 3100a, for carriage 3100 to reciprocate in the scanning direction, extends in the scanning direction. Carriage 3100 reciprocates within space 3100a in the scanning direction, so that head 1000 reciprocates also in the scanning direction. Scanner 3000 comprises a pair of carriage shafts 3200 for guiding carriage 3100, carriage driving motor 3300, and carriage driving belt 3400 for transferring carriage 3100. This pair of carriage shafts 3200 extend in the scanning direction and are disposed in parallel with the transfer direction. Pair shafts 3200 extend through and guide carriage 3100, so that carriage 3100 moves along pair shafts 3200.

Belt 3400 winds on driver pulley 3400a and follower pulley 3400b spaced each other in the scanning direction. Motor 3300 is adjacent to space 3100a with respect to the transfer direction and disposed on a first side of the scanning direction. As shown in FIG. 14, motor 3300 is disposed on the side of carriage 3100 with respect to the transfer path, i.e., upstream side in the ink ejecting direction with respect to the transfer path (Z direction shown in FIG. 14). Pulley 3400a is mounted to a rotary shaft of motor 3300, and spinning of motor 3300 entails pulley 3400a to spin. The spin of pulley 3400a is transferred to pulley 3400b via belt 3400.

On carriage 3100, engaging section 3100b for engaging with belt 3400 is formed. When belt 3400 is driven, engaging section 3100b is moved by belt 3400. Therefore, the rotary shaft of motor 3300 is normally driven or reversedly driven, so that carriage 3100 reciprocates in the scanning direction.

Frame 6100, of which cross sectional view shapes in a reversed letter “L”, is placed such that it extends in the scanning direction between space 3100a and motor 3300, and defines space 3100a. At the bent section on the upper end of frame 6100, linear scale 7100 is disposed for detecting a position of carriage 3100 with respect to the scanning direction. In other words, scale 7100 is located above carriage 3100 and extends in the scanning direction.

On the other hand, on the upper face of carriage 3100, detecting sensor 7200 is disposed. Sensor 7200 faces linear scale 7100 to detect it. Sensor 7200 detects a position of carriage 3100 in the scanning direction, and based on this detected position, rotational control of motor 3300 is performed.

Transfer machine 4000 comprises (a) transfer motor 4200, a driving source for transferring recording paper 4100, (b) a pair of transfer roller 4300 for pinching paper 4100 to transfer, and (c) a pair of discharging roller 4550 for pinching and discharging paper 4100. Motor 4200 is disposed at a place adjacent to space 3100a and on a second side of the scanning direction. In other words, as shown in FIG. 15, motor 4200 is away from motor 3300 in the scanning direction (X direction.) The pair of rollers 4300 facing each other extend respectively in the scanning direction. One of the rollers 4300 is coupled to a rotating shaft of motor 4200 via a plurality of gears 4500. Thus this roller 4300 rotates around the motor shaft following the rotation of the shaft of motor 4200.

The pair of discharging rollers 4550, facing each other, extend respectively in the scanning direction, and are disposed in parallel with pair-rollers 4300 in the transfer direction. Pulleys 4600a and 4600b are disposed respectively at the end of one of pair-rollers 4300 and pair-rollers 4550. This pair of pulleys have the same diameter, and transmission belt 4600 winds on these pulleys. This structure allows roller 4550 to rotate by belt 4600 at the same rotating speed and in the same direction as roller 4300 simultaneously.

Accordingly, when motor 4200 spins, paper 4100 pinched by pair-rollers 4300 is transferred to just under heads 1000, while another paper 4100 pinched by pair-rollers 4550 is discharged from just under heads 1000 in the transfer direction.

Between rollers 4300 and rollers 4550, platen 4700 is disposed on the reverse side to head 1000 with respect to paper 4100, so that wrinkles or looseness on paper 4100 can be prevented. Thus a quality picture can be recorded.

Recording heads 1000 disposed to carriage 3100, as shown in FIG. 16, comprise the following elements:

(a) a plurality of pressuring chambers 1100 in which colored inks such as yellow, magenta, cyan and black are filled;

(b) a plurality of nozzle-holes 1200 disposed on walls defining respective chambers 1100, and for ejecting the inks from chambers 1100; and

(c) actuators 1300 actuating and deforming so that capacities of respective chambers 1100 decrease.

Ink flow-paths 1100a, through which the ink is supplied, communicate with chambers 1100. These paths 1100a are coupled to ink-tank 5300 via ink-supplying-tubes 5200.

Actuator 1300 is disposed on the walls of chambers 1100 facing the walls on which nozzle-holes 1200 are formed. Actuator 1300 is formed by piezoelectric film pinched by a pair of electrodes. A pulse is applied over the pair of electrodes, and a rise of pulse voltage makes actuator 1300 bow downwardly (protrudes inside of chamber 1100) due to bimetal effect. This deflection ejects the ink in chamber 1100 through nozzle-hole 1200 to paper 4100. On the other hand, a fall of pulse voltage restores actuator 1300, then ink is filled in chamber 1100 through flow path 1100a.

The voltage applied to actuator 1300 is controlled by head driving circuit 1500. Driving circuit 1500 controls the deforming of actuator 1300, so that ejection of the ink is controlled. Ink tanks 5300 accommodate respective colored ink independently, and are aligned in the scanning direction at a place adjacent to space 3100a in the transfer direction as shown in FIGS. 14 and 15. Thus tanks 5300 are located on the same side as motor 3300 with respect to space 3100a. As such, four tanks 5300 are aligned in the scanning direction, thereby increasing respective capacities of tanks 5300.

Tubes 5200 are provided to respective colored inks, and four tubes 5200 are aligned in the ejecting direction (Z axis direction) and integrated into one unit. Tubes 5200 are coupled to carriage 3100 on the other side of tanks 5300 with respect to the transfer direction, and bowed upwardly in space 3100a and arrive at tanks 5300 on its closer side to space 3100a. Tubes 5200 are routed to outside of space 3100a via coupling section 6100a which is disposed at approx. center of frame 6100 in the scanning direction and above carriage shaft 3200 as well as carriage driving belt 3400 in the ejecting direction (Z axis direction). Thus tubes 5200 run above carriage shaft 3200 and belt 3400. Outside space 3100a, tubes 5200 are separated to respective colors and coupled to four tanks 5300 independently.

Among a plurality of ink tanks 5300, an ink tank, which contains the ink of the highest viscosity, is placed closest to coupling section 6100a, i.e., at the middle in the scanning direction (X axis direction.) The highest viscosity ink is, for instance, an ink of pigment system.

A tank containing the most consumable ink may be disposed closest to coupling section 6100a. The most consumable ink is actually black ink. From coupling section 6100a to carriage 3100, electric wiring 6200, including power lines and others, is integrally routed along tubes 5200. Wiring 6200 is coupled to driving circuit 1500 of carriage 3100.

An operation and advantages of the tenth embodiment are demonstrated hereinafter. Since ink-supplying-tubes 5200 are routed through carriage moving space 3100a, no additional space specifically for tubes 5200 is required. As a result, the apparatus can be downsized.

Tubes 5200 reciprocate within space 3100a following the reciprocation of carriage 3100. At this time, tubes 5200 do not interfere with the reciprocation of carriage 3100 and vice versa. (Refer to chain lines in FIG. 15.) As a result, the ink is supplied to recording heads 1000 in a stable manner.

Further, ink tanks 5300 and carriage driving motor 3300 are placed on the same side as space 3100a with respect to the transfer direction (Y axis direction), thus the apparatus can be downsized in the transfer direction.

Still further, tanks 5300 are disposed close to carriage 3100, therefore, the length of tubes 5200 becomes short. As a result, flow-path resistance against the ink becomes less, thus the ink can be supplied to recording heads 1000 in a stable manner.

Ink tank 5300, containing the ink of the highest viscosity or the most consumable ink, is disposed at the middle of tanks 5300 in the scanning direction (X axis direction), thus the ink can be supplied with the shorter tube length to head 1000. As a result, flow path resistance against the ink becomes less, and the apparatus achievable of stable recording can be obtained.

Further, coupling section 6100a is placed approx. at the center of frame 6100 in the scanning direction (X axis direction), so that a flowing length of tube 5200 disposed in space 3100a can be minimized. The flowing lengths of tubes 5200 between coupling section 6100a and respective tanks can be approx. equal to each other. As a result, inks contained in any tanks can be supplied to heads 1000 in the stable manner. In addition, tubes 5200 are coupled to carriage 3100 at a distant side in the transfer direction with respect to tanks 5300, which gives tubes 5200 greater curvatures, and flow-path resistance against the ink decreases. As a result, the inks can be supplied to heads 1000 in the stable manner.

Electric wiring 6200 is routed integrally with tubes 5200, so that no additional space is required for wiring 6200. As a result, the apparatus can be further downsized, and electric wiring 6200 does not interfere with the moving of carriage 3100 and tubes 5200.

First Modification

FIG. 17 illustrates an inkjet recording apparatus in accordance with the first modification. In this modification, carriage shaft 3200 is disposed at a different place from the tenth embodiment. To be more specific, in this modification, a pair of carriage shafts 3200 are disposed in the ejecting direction (Z axis direction), and a pair of ink-supplying-tubes 5200 are routed between the pair of carriage shafts 3200.

Other elements and structures are the same as those in the tenth embodiment, and the same elements are denoted with the same reference marks. The descriptions thereof are thus omitted here. In this modification, no additional space is required for routing tubes 5200, which are routed in an optimum manner, so that the inks can be supplied to heads 1000 in a stable manner.

Second Modification

FIG. 18 illustrates an inkjet recording apparatus in accordance with the second modification. In the second modification, linear scale 7100 is disposed at a different place from the first modification. To be more specific, scale 7100 is disposed on the depending wall of frame 6100, i.e., disposed at carriage 3100 on the side of the transfer direction, and detecting sensor 7200, which detects scale 7100, is disposed on the side of carriage 3100 closer to tanks 5300.

Other elements and structure are the same as those in the tenth embodiment, and the same elements are denoted with the same reference marks. The descriptions thereof are thus omitted here. Carriage shafts 3200, linear scale 7100 and carriage driving belt 3400 are thus placed so as not to interfere with tubes 5200.

Eleventh Exemplary Embodiment

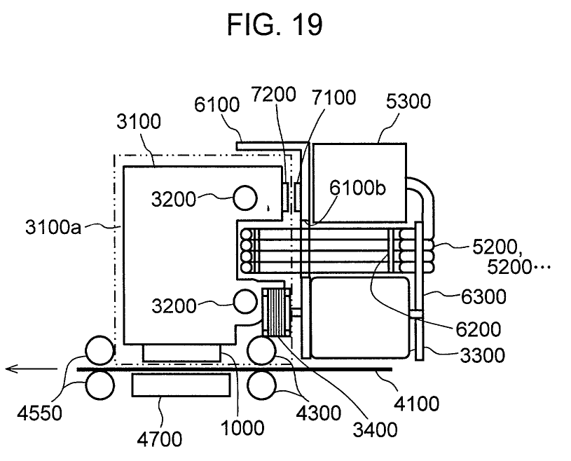

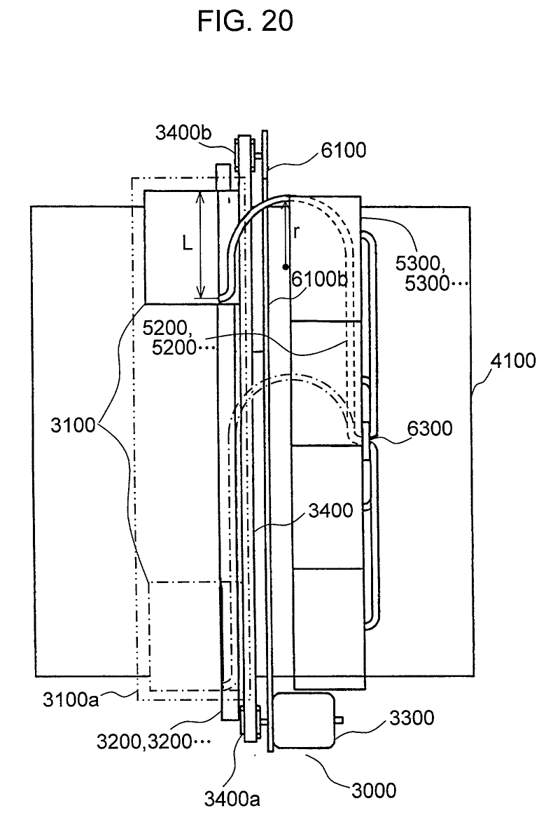

FIG. 19 is a lateral view of an inkjet recording apparatus in accordance with the 11th exemplary embodiment. FIG. 20 is a plan view of the same inkjet recording apparatus.

This 11th embodiment tries downsizing the apparatus in a scanning direction. In FIG. 20, plus side in X direction is referred to as a first side of the scanning direction, minus side thereof is a second side of the scanning direction. Minus side in Y direction is referred to as a first side of the transfer direction and plus side thereof is a second side of the transfer direction.

In the 11th embodiment, ink-supplying-tubes 5200 are coupled to carriage 3100 on its first side of the transfer direction (Y axis direction.) Tubes 5200 is routed through slit 6100b formed on frame 6100 and extending in the scanning direction (X axis direction), and adjacent to carriage moving space 3100a on the first side of the transfer direction (Y axis direction.) Thus tubes 5200 bow upward (protrude) to the first side of the scanning direction.

Tubes 5200 are coupled to carriage 3100 in parallel with an ejecting direction (Z axis direction.) The coupling section of tubes 5200 to carriage 3100 is set on the second side of the scanning direction on carriage 3100 as shown in FIG. 20. The distance “L” between an end of the first side of the scanning direction on carriage 3100 and the coupling section is longer than curvature diameter “r” of the bowed section of tubes 5200.

Tanks 5300 are placed adjacent to space 3100a on the first side of the transfer direction (Y axis direction), and is disposed on the upstream side with respect to tubes 5200 in the ejecting direction (Z axis direction.) Tubes 5200 are routed under tanks 5300 in the ejecting direction, and coupled to the side of respective tanks 5300 on the first side of the transfer direction via coupling sections 6300 apart with each other on the first side of frame 6100 in the transfer direction. Coupling sections are located approx. at the center in the scanning direction (X axis direction.)

Carriage driving motor 3300 of scanner 3000 is placed on the second side of the scanning direction (X axis direction), which differs from the tenth embodiment. In FIG. 20, transfer machine 4000 is omitted; however, other structures including transfer machine 4000 are the same as that in the tenth embodiment. Thus the same elements are denoted with the same reference marks and the descriptions thereof are thus omitted here.

In this 11th embodiment, tubes 5200 are bowed at the place adjacent to space 3100a on the first side of the transfer direction (Y axis direction), therefore, tubes 5200 can have rather large curvature diameter “r”. As a result, flow path resistance against the ink lowers and the ink can be supplied in a stable manner.

The coupling section of tubes 5200 to carriage 3100 is set on the second side of the scanning direction with reference to an end of the first side of the scanning direction on carriage 3100 exceeding curvature radius “r” (refer to distance “L” in FIG. 20.) Thus when carriage 3100 is moved to the end of the first side of the scanning direction in space 3100a, tubes 5200 bow at the place adjacent to carriage 3100 on the first side of the transfer direction. The top of the bowed section will not extend in the scanning direction (X axis direction) from the first side of the scanning direction on carriage 3100 (refer to solid lines in FIG. 20.) In other words, tubes 5200 are placed on the second side of the scanning direction from the end of the first side of the scanning direction on carriage 3100. As a result, the inkjet recording apparatus can be downsized in the scanning direction (X axis direction.)

Ink tanks 5300 are placed at the place adjacent to space 3100a on the first side of the transfer direction, and placed on the upstream side of the ejecting direction (Z axis direction) with respect to tubes 5200. Thus tanks 5300 are overlaid tubes 5200 viewed from the ejecting direction (Z axis direction.) As a result, the apparatus can be downsized both in the scanning direction (X axis direction) and in the transfer direction (Y axis direction.)

Tanks 5300 are disposed in the vicinity of carriage 3100, therefore, the length of flow path of tube 5200 can be shorter, and the ink can be supplied in the stable manner.

The present invention is not limited to the 10th and 11th embodiments, and various modifications can be available. To be more specific, in the 10th embodiment, ink-supplying-tubes 5200 are coupled to carriage 3100 at the side distant from tanks 5300 in the transfer direction; however, the coupling section is not limited to this one.

In the 11th embodiment, tanks 5300 are placed on the upstream side of tubes 5200 in the ejecting direction; however, tubes 5200 can be placed on the downstream side of tubes 5200.

Further in the 11th embodiment, tubes 5200 are placed on the second side of the scanning direction from the first side thereof on carriage 3100; however, tubes 5200 can be placed a little bit outside from the end of the first side of the scanning direction on carriage 3100.

Still further, in the 10th and 11th embodiments, sub-tanks can be provided to carriage 3100 for temporary pooling of the inks supplied from tanks 5300, the sub-tanks may be placed between tanks 5300 and heads 1000.

As discussed above, according to the apparatuses described in the 10th and 11th embodiments, the ink-supplying-tubes are routed through the carriage moving space, therefore, no additional space is required specifically for the tubes. As a result, the apparatus can be downsized.

The tubes are routed so that the flow-path length can be shorter and flow-path resistance against the ink can be lowered. As a result, the ink can be supplied to the heads in the stable manner.

Further, the ink-supplying-tubes are bowed and placed at the place adjacent to the carriage moving space on the first side of the transfer direction. This structure allows the tubes to have a larger curvature diameter, which realizes stable ink supply to the heads. At the same time, the coupling section of the tubes to the carriage is located on the carriage on the second side of the scanning direction from the first side thereof, so that the apparatus can be downsized particularly in the scanning direction.

What is claimed is:

1. An inkjet recording apparatus comprising:
a recording head provided to a carriage and ejecting a plurality of colored inks from nozzles;
ink-tanks for pooling the respective colored inks; and
a plurality of ink supplying tubes coupling the recording heads to the ink-tanks for supplying the respective colored inks pooled in the tanks to the recording heads,
wherein a predetermined colored ink among the plurality of colored inks is ejected greater amount per unit time than other colored inks, and an ink supplying tube for the predetermined colored ink supplies the ink greater amount per unit time than tubes for other colored inks.

2. The inkjet recording apparatus as defined in claim 1, wherein the ink supplying tube for the predetermined colored ink has a larger diameter along at least a part of a length of the tube than the other tubes.

3. The inkjet recording apparatus as defined in claim 1, wherein a number of the ink supplying tubes for the predetermined color ink is greater than those of the tubes for other colored inks.

4. The inkjet recording apparatus as defined in claim 3, wherein the ink supplying tubes for the predetermined colored ink are independently formed.

5. The inkjet recording apparatus as defined in claim 3, wherein at least two ink supplying tubes for the predetermined colored ink are integrally formed.

6. The inkjet recording apparatus as defined in claim 1, wherein a length of the ink supplying tube for the predetermined colored ink is shorter than those of other colored tubes.

7. An inkjet recording apparatus comprising:
recording heads provided to a carriage and ejecting a plurality of colored inks from nozzles;
ink-tanks for pooling the respective colored inks; and
a plurality of ink supplying tubes coupling the recording heads to the ink-tanks for supplying the respective colored inks pooled in the tanks to the recording heads,
wherein viscosity of a predetermined colored ink among the plurality of colored inks is greater than other colored inks, and a ink supplying tube for the predetermined colored ink supplies the ink not less than tubes for other colored inks per unit time.

8. The inkjet recording apparatus as defined in claim 7, wherein the ink supplying tube for the predetermined colored ink has a larger diameter along at least a part of a tube length than other tubes.

9. The inkjet recording apparatus as defined in claim 7, wherein a number of the ink supplying tubes for the predetermined colored ink is greater than those of the tubes for other colored inks.

10. The inkjet recording apparatus as defined in claim 9, wherein the ink supplying tubes for the predetermined colored ink are independently formed.

11. The inkjet recording apparatus as defined in claim 9, wherein at least two ink supplying tubes for the predetermined colored ink are integrally formed.

12. The inkjet recording apparatus as defined in claim 7, wherein a length of the ink supplying tubes for the predetermined colored ink is shorter than those of other tubes.

13. An inkjet recording apparatus comprising:
a scanner including a carriage driving motor which reciprocates a carriage having a recording head in a scanning direction (X axis direction); and
a transfer machine including a transfer motor which transfers a recording medium in a transfer direction (Y axis direction) perpendicular to the scanning direction;
wherein both of the motors are located approx. at the same place in an ejecting direction (Z axis direction), and the place is set one of at a height of a transfer path of the recording medium and on a side of the carriage with respect to the transfer path.

14. The inkjet recording apparatus as defined in claim 13, wherein the carriage driving motor is disposed on a first side of the scanning direction and at a place adjacent to a carriage moving space where the carriage reciprocates, and the transfer motor is placed on a second side of the scanning direction opposite to the carriage driving motor,
wherein at least one of elements constituting said apparatus is placed between both the motors and on the carriage side in Z axis direction with respect to the transfer path.

15. The inkjet recording apparatus as defined in claim 14, wherein the one of elements is an ink tank for containing ink to be supplied to the recording head.

16. The inkjet recording apparatus as defined in claim 14, wherein the one of elements is a power supply for powering at least one of the scanner and the transfer machine.

17. The inkjet recording apparatus as defined in claim 14, wherein the one of elements is a controller for controlling at least one of the scanner and the transfer machine.

18. The inkjet recording apparatus as defined in claim 14, wherein the one of elements is a feeder for feeding a recording medium to the transfer machine.

19. The inkjet recording apparatus as defined in claim 13 further comprising:
a first ink-tank provided to the carriage and containing ink to be supplied to the recording head; and
a second ink-tank communicating with the first ink-tank,
wherein said second ink-tank follows reciprocation of the carriage and reciprocates in a tank moving space, and
wherein the carriage driving motor is placed on a first side of the scanning direction and adjacent to the tank moving space, and the transfer motor is placed on a second side of the scanning direction opposite to the carriage driving motor and adjacent to the tank moving space.

20. An inkjet recording apparatus comprising:
a carriage having a recording head and for reciprocating in a scanning direction;
an ink-tank for containing ink to be supplied to the recording head; and
an ink supplying tube for coupling the carriage to said ink-tank and being routed from said carriage through a carriage moving space, where said carriage reciprocates, to said ink-tank,
wherein the ink ejected from the recording head is attached to a recording medium, which is transferred in a transfer direction perpendicular to the scanning direction, for recording.

21. The inkjet recording apparatus as defined in claim 20 further comprising a carriage driving motor for reciprocating said carriage, wherein said carriage driving motor and said ink-tank are placed adjacent to each other on the same side of the transfer direction with respect to the carriage moving space.

22. An inkjet recording apparatus comprising:
(a) recording heads for ejecting different colored inks from each other;
(b) a carriage having said heads and for reciprocating in a scanning direction (X axis direction);
(c) a plurality of ink-tanks aligned in the scanning direction and for containing respective colors to be supplied to said heads;
(d) ink supplying tubes routed from said carriage through a carriage moving space, where said carriage reciprocates, to said ink-tanks and for coupling said carriage to said ink-tanks; and
(e) a coupling section disposed on said ink-tanks side of the carriage moving space, and for bundling said ink supplying tubes,
wherein among said plurality of ink-tanks, a tank containing ink having a highest viscosity is placed closer to said coupling section than other tanks, and inks ejected from said recording heads are attached to a recording medium, transferred in a transfer direction (Y axis direction) perpendicular to the scanning direction, for recording.

23. An inkjet recording apparatus comprising:
(a) recording heads for ejecting different colored inks from each other;
(b) a carriage having said heads and for reciprocating in a scanning direction (X axis direction);
(c) a plurality of ink-tanks aligned in the scanning direction and for containing respective colors to be supplied to said heads;
(d) ink supplying tubes routed from said carriage through a carriage moving space, where said carriage reciprocates, to said ink-tanks and for coupling said carriage to said ink-tanks; and
(e) a coupling section disposed on said ink-tanks side of the carriage moving space, and for bundling said ink supplying tubes,
wherein among said plurality of tanks, a tank containing a most consumable ink is placed closer to said coupling section than other tanks, and inks ejected from said recording heads are attached to a recording medium, transferred in a transfer direction (Y axis direction) perpendicular to the scanning direction, for recording.

24. The inkjet recording apparatus as defined in claim 22, wherein said coupling section is disposed approx. at a center of the carriage moving space in the scanning direction.

25. The inkjet recording apparatus as defined in claim 23, wherein said coupling section is disposed approx. at a center of the carriage moving space in the scanning direction.

26. The inkjet recording apparatus as defined in claim 22, wherein said ink supplying tubes are coupled to said carriage on a distant side from said ink-tanks.

27. The inkjet recording apparatus as defined in claim 23, wherein said ink supplying tubes are coupled to said carriage on a distant side from said ink-tanks.

28. The inkjet recording apparatus as defined in claim 22, wherein an electric wiring coupled to said carriage is disposed integrally with said ink supplying tubes.

29. The inkjet recording apparatus as defined in claim 23, wherein an electric wiring coupled to said carriage is disposed integrally with said ink supplying tubes.

30. The inkjet recording apparatus as defined in claim 22 further comprising elements disposed extendedly in the scanning line in a manner of:
a linear scale for detecting a position of said carriage in the scanning direction;
a carriage driving belt for transferring said carriage in the scanning direction; and
a carriage shaft for guiding said carriage to move in the scanning direction,
wherein said linear scale, said carriage driving belt, and said carriage shaft are placed between said carriage and said ink-tanks, and free from interfering with said ink supplying tubes.

31. The inkjet recording apparatus as defined in claim 23 further comprising elements disposed extendedly in the scanning line in a manner of:
a linear scale for detecting a position of said carriage in the scanning direction;
a carriage driving belt for transferring said carriage in the scanning direction; and
a carriage shaft for guiding said carriage to move in the scanning direction,
wherein said linear scale, said carriage driving belt, and said carriage shaft are placed between said carriage and said ink-tanks, and free from interfering with said ink supplying tubes.

32. An inkjet recording apparatus comprising:
(a) a recording head for ejecting ink;
(b) a carriage having said head and for reciprocating in a scanning direction (X axis direction);
(c) an ink-tank for containing ink to be supplied to said head; and
(d) an ink supplying tube for coupling said carriage to said ink-tank,
wherein said ink supplying tube is coupled to said carriage on a side in a transfer direction (Y axis direction) perpendicular to the scanning direction, and bowed to a first side of the scanning direction (X axis direction) in a space adjacent to a carriage moving space, where said carriage reciprocates, on a same side in Y axis direction, and when said carriage is located at an end of the first side in the scanning direction, a top of a bowed section is located one of at approx. the same position as the end of the first side in the scanning direction (X axis direction) and at a second side in X axis direction from the end of the first side.

33. The inkjet recording apparatus as defined in claim 32, wherein said ink-tank, in a space adjacent to a side of the carriage moving space in the transfer direction (Y axis), are placed above or below said ink supplying tube in a direction (Z axis direction) perpendicular both to the scanning direction (X axis direction) and the transfer direction (Y axis direction.)
